(19) United States
(12) Patent Application Publication
(10) Pub. No.: US 2010/0140089 A1
(43) Pub. Date: Jun. 10, 2010

(54) FLEXIBLE pH SENSORS AND pH SENSING SYSTEMS USING THE SAME

(75) Inventors: Jung-Chuan Chou, Yunlin (TW); Tai-Ping Sun, Taoyuan (TW); Shen-Kan Hsiung, Taoyuan (TW); Nien-Hsuan Chou, Taoyuan (TW); Sheng-Kai Li, Taoyuan (TW)

Correspondence Address: MARTINE PENILLA & GENCARELLA, LLP, 710 LAKEWAY DRIVE, SUITE 200, SUNNYVALE, CA, 94085, US

(73) Assignee: Chang Jung Christian University, a Taiwan Corporation, Tainan (TW)

(21) Appl. No.: 12/469,627

(22) Filed: May 20, 2009

(30) Foreign Application Priority Data
Dec. 5, 2008 (TW) 97147394

(51) Int. Cl. G01N 27/333

(52) U.S. Cl. 204/433

(57) ABSTRACT

This invention provides an extended gate ion-sensitive field effect transistor as a pH sensor for measuring the pH value of a solution under test. This invention also provides a pH sensing system comprising a separable and flexible pH sensor for measuring the pH value of a solution under test, wherein the transistor of the pH sensor can be prevented from direct contact with the solution.

### CROSS-REFERENCE TO RELATED APPLICATION

This application claims the priority benefit of Taiwan application serial no. 97147394, filed on Dec. 5, 2008. All disclosure of the Taiwan application is incorporated herein by reference.

### BACKGROUND OF THE INVENTION

The present invention relates to a pH sensor. More specifically, the present invention relates to a pH sensor based on an extended gate ion-sensitive field effect transistor (EGFET) architecture.

Conventional ion-selective glass electrodes have many advantages such as high linearity, excellent ion selectivity and good stability. However, they are large and expensive, and the reaction time thereof is long. Therefore, conventional ion-selective glass electrodes were gradually replaced by ion-sensitive field effect transistors using the established silicon semiconductor technology.

In 1970, Piet Bergveld (P. Bergveld, IEEE Transaction Biomedical Engineering, BME-17, pp. 70-71, 1970) proposed an ion-sensitive field effect transistor (ISFET), which was fabricated by removing the metal film on the gate electrode of a general MOS field effect transistor (MOSFET) and immersing the intermediate device into an aqueous solution. The oxide layer on the gate electrode of the ISFET serves as an insulating ion sensing membrane. When the oxide layer is in contact with solutions with different pH values, different potential changes will be induced at the interface thereof with solutions so that the current passing the channel of the MOSFET is changed accordingly. Thus, by measuring the current change, it is possible to figure out the pH value or the concentration of some other ions in the aqueous solution.

In the 1970's, the development and application of ISFETs were still in the exploration stage. However, in the 1980's, the studies of ISFETs on basic theoretical researches, crucial technologies or practical applications had been greatly progressed. For example, based on the architecture of ISFETs, more than 20˜30 kinds of field effect transistors were fabricated for measuring the concentration of a variety of ions and chemical substances. Besides, ISFETs had improved greatly in the aspects of miniaturization, modularizing or multi-functioning. The major reason why ISFETs had become so popular globally is that they have the following special advantages, which conventional ion-selective electrodes lack:

1. Volume being small and microanalysis being feasible;

2. High input resistance and low output resistance;

3. Fast response; and

4. Process compatibility with MOSFETs.

Afterward, J. Spiegel (J. V. D. Spiegel et al., Sensors and Actuators, 4, pp. 291-298, 1983) proposed an extended gate ion-sensitive field effect transistor (EGFET or EGISFET), which is derived from the ISFET. In contrast to the traditional ISFET, the EGFET retains the metal gate of the MOSFET and the sensing membrane thereof is placed at the terminal of a signal lead extended from the metal gate. Thus, only the sensing membrane needs to be immersed in the solution under test, but the field effect transistor does not. Compared with the traditional ISFET, the EGFET has the following advantages: (1) a conductor thereof provides electrostatic protection for the sensor; (2) the transistor of the sensor can be prevented from direct contact with the aqueous solution, which reduces the failure rate thereof; and (3) the influence of light on the sensor can be reduced.

### SUMMARY OF THE INVENTION

It is a primary objective of the present invention to provide an extended gate ion-sensitive field effect transistor (EGFET) served as a pH sensor for measuring the pH value of a solution under test.

Another objective of the present invention is to provide a flexible pH sensor having good sensitivity, linearity and stability.

Yet another objective of the present invention is to provide a flexible pH sensor having a lot of advantages such as simple process equipment, low cost, and easy mass production.

Still another objective of the present invention is to provide a pH sensing system having a separable and flexible pH sensor for measuring the pH value of the solution under test, wherein the transistor of the sensor is not in direct contact with the solution under test.

To achieve the foregoing objectives, the present invention provides a flexible pH sensor, comprising a flexible plastic substrate, an indium tin oxide (ITO) layer formed on the flexible plastic substrate, a sensing membrane formed on the ITO layer, and a sealant configured to encapsulate the flexible plastic substrate, the ITO layer and the sensing membrane, wherein a portion of an upper surface of the sensing membrane is exposed to form a sensing window.

The present invention provides a pH sensing system for measuring the pH value of a liquid, comprising a flexible pH sensor, a readout circuit and a conductor. The flexible pH sensor comprises a flexible plastic substrate, an ITO layer formed on the flexible plastic substrate, a sensing membrane formed on the ITO layer, and a sealant configured to encapsulate the flexible plastic substrate, the ITO layer and the sensing membrane, wherein a portion of an upper surface of the sensing membrane is exposed to form a sensing window. The readout circuit is configured to read the output signal from the flexible pH sensor. The conductor has a first end connected to the flexible pH sensor and a second end connected to the readout circuit.

### BRIEF DESCRIPTION OF THE DRAWINGS

FIG. 1 is a schematic diagram of a flexible pH sensor according to one embodiment of the present invention.

FIG. 2 is a schematic diagram of a pH sensing system according to one embodiment of the present invention.

FIG. 3 shows the relation between the pH value and the output voltage measured by the pH sensing system in FIG. 2 operating at a temperature of 25° C.

### DETAILED DESCRIPTION OF THE PREFERRED EMBODIMENTS

The technical contents, features, and effect of the present invention will be presented in more detail with reference to the following preferred embodiments thereof. In the following description, numerous specific details are set forth in order to provide a thorough understanding of the present invention. It will be apparent, however, to one skilled in the art, that the present invention may be practiced without some or all of these specific details. In other instances, well known steps and/or structures have not been described in detail in order not to unnecessarily obscure the present invention.

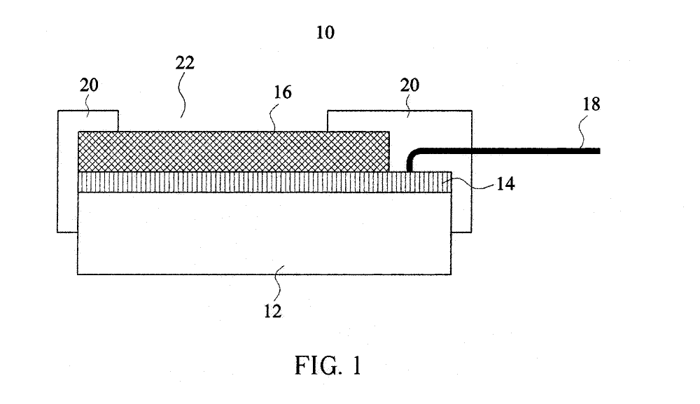

FIG. 1 is a schematic diagram of a pH sensor 10 according to one embodiment of the present invention. The pH sensor 10 is an extended gate ion-sensitive field effect transistor, comprising a substrate 12, an ITO layer 14, a sensing membrane 16, a conductor 18 and a sealant 20.

The substrate 12 is made of plastic material. In one embodiment, the substrate 12 is made of polyethylene terephthalate (PET), which has a lot of advantages such as high availability, low price, heat and wear resistance, and flexibility. In another embodiment, other plastic composite material with high-temperature resistance can be used, such as semi-crystalline thermoplastic and amorphous thermoplastic. The semi-crystalline thermoplastic can be poly(phenylene sulfide) (PPS), poly(ether-ether-ketone) (PEEK), poly(ether-ketone-ketone) (PEKK) and polyphthalamide (PPA), and the amorphous thermoplastic can be poly(ether sulfone) (PES), poly(etherimide) (PEI) and polysulfone (PSU). In still another embodiment, reinforced fiber, e.g. carbon fiber or glass fiber, can be incorporated into the plastic composite material with high-temperature resistance. The ITO layer 14 is formed on the plastic substrate 12. Then, the sensing membrane 16 is formed on the ITO/substrate. In one embodiment, the sensing membrane is tin dioxide (SnO₂) film. In another embodiment, the sensing membrane can be other metal oxide film (such as zinc oxide film) or Ti—Ni film.

In one embodiment, an ITO/PET substrate with resistivity of 4˜7 ohm-cm (SiPix Technology, Inc.) is cut into a desired size, and then washed respectively using methanol and deionized water in a ultrasonic oscillator for a period of time. A SnO₂ film 16 with thickness of 2000 angstrom (Å) is then deposited on the ITO/PET substrate by using a metallic mask and a radio frequency (RF) sputtering. During the sputtering, the target is SnO₂ and the process gas is a mixture of argon and oxygen with a ratio of 4:1. Besides, the substrate temperature is kept at 100° C., the pressure is kept at 20 mTorr and the RF power is 50 Watt during the deposition process.

After the deposition of the SnO₂ film 16, a conductor 18 is fixed onto a reserved portion of the ITO layer 14 by using a silver paste, and then the conductor/SnO₂/ITO/substrate is placed in a high-temperature oven for baking for a period of time. Then, by using the known technique in the art, the component is encapsulated by a sealant 20, wherein a portion of an upper surface of the SnO₂ film 16 is exposed to form a sensing window 22. After the encapsulation, the component is placed in the oven for a period of time. After the hardening of the sealant 20, the manufacture of the flexible pH sensor 10 is completed.

The conductor 18 is made of a metal. In one embodiment, the conductor 18 is made of aluminum. The sealant 20 is an epoxy resin; however, other materials having the characteristics of good sealability, corrosion resistance, light blocking property and water insolubility can be used, such as UV curable adhesives and polyvinyl chloride.

When the exposed SnO₂ film 16 is in contact with an acid or base solution, hydrogen ions are adsorbed onto the exposed surface of the SnO₂ film 16 to induce a surface potential thereon. Via the conductor 18, the induced surface potential influences the threshold voltage of the MOSFET at the other end, and further influences the channel current thereof. Since the surface potential is related to the concentration of hydrogen ions within the solution, when the pH value changes, different surface potential is induced on the SnO₂ film 16, which further leads to different channel current of the MOSFET at the other end. Therefore, the pH value of the solution can be derived from the channel current of the MOSFET.

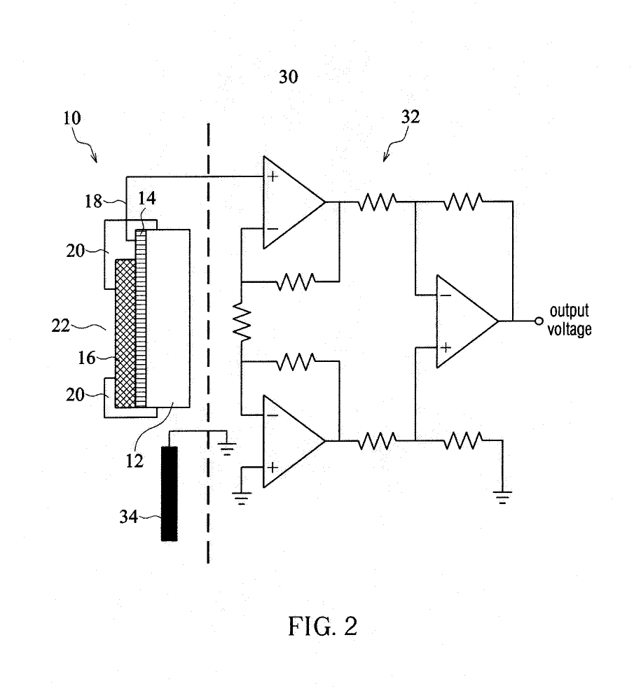

FIG. 2 is a schematic diagram of a pH sensing system 30 according to one embodiment of the present invention. The pH sensing system 30 comprises a flexible pH sensor 10 as mentioned above and a readout circuit 32. The readout circuit 32 is configured to read the output signal from the flexible pH sensor 10, which is coupled to the readout circuit 32 via a conductor 18. The flexible pH sensor 10 has a separable architecture of sensing membrane/ITO/plastic substrate (i.e. EGFET) as a transducer. The flexible pH sensing system 30 further comprises a reference electrode 34 configured to provide a stable potential. In one embodiment, the reference electrode 34 is a silver/silver chloride (Ag/AgCl) reference electrode. The flexible pH sensor 10 and the reference electrode 34 are immersed in the solution under test, and then the response of the sensor can be obtained by using the readout circuit 32 at the other end. In one embodiment, the readout circuit 32 is an instrumentation amplifier, such as LT1167, which has two input ends and one output end, and the two input ends are connected respectively to the flexible pH sensor 10 and the reference electrode 34.

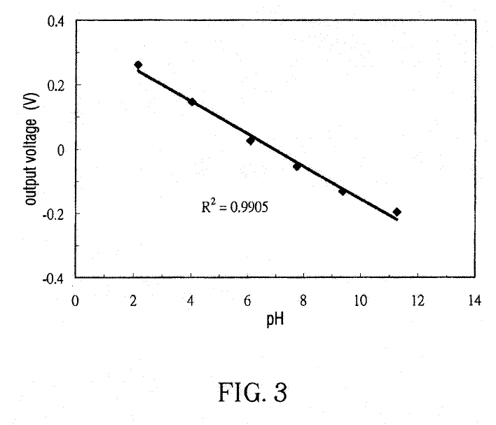

FIG. 3 shows the relation between the pH value and the output voltage measured by the pH sensing system 30 in FIG. 2. In the light of FIG. 3, the output voltage measured by the pH sensing system 30 decreases with the increasing pH value, and the relationship therebetween is linear. Thus, the pH value of the solution can be derived from the output voltage measured by the pH sensing system 30 according to the linear relationship mentioned above. In this embodiment, the pH sensing system 30 has a sensitivity average of about −50.6 mV/pH. Therefore, the flexible pH sensor 10 and pH sensing system 30 provided in the present invention are suitable for measuring the pH value of solutions under test.

Summing up the above, the present invention provides a flexible pH sensor 10 and a pH sensing system 30 having the following advantages at least:

(1) the conductor thereof provides electrostatic protection for the sensor;

(2) the transistor of the sensor can be prevented from direct contact with aqueous solutions;

(3) they are suitable for mass production and can be manufactured by simple process equipments; and

(4) the pH sensor is cheap and meets the requirement of a disposable component.

While some embodiments of the present invention are described above, it is intended that the scope of the invention be limited not by this detailed description, but rather by the claims appended hereto. Besides, it is intended that the following appended claims be interpreted as including all such alterations, permutations, and equivalents as fall within the true spirit and scope of the present invention.

What is claimed is:

1. A flexible pH sensor, comprising:
a flexible plastic substrate;
an indium tin oxide (ITO) layer formed on the flexible plastic substrate;
a sensing membrane formed on the ITO layer; and
a sealant configured to encapsulate the flexible plastic substrate, the ITO layer and the sensing membrane, wherein a portion of an upper surface of the sensing membrane is exposed to form a sensing window.

2. The flexible pH sensor of claim 1, further comprising a conductor, wherein the conductor is coupled to the ITO layer.

3. The flexible pH sensor of claim 1 or 2, wherein the flexible plastic substrate is made of polyethylene terephthalate (PET).

4. The flexible pH sensor of claim 1 or 2, wherein the sensing membrane is a tin dioxide (SnO₂) film.

5. The flexible pH sensor of claim 1 or 2, wherein the sealant is an epoxy resin.

6. A pH sensing system for measuring pH value of a liquid, comprising
a flexible pH sensor, comprising:
a flexible plastic substrate;
an indium tin oxide (ITO) layer formed on the flexible plastic substrate;
a sensing membrane formed on the ITO layer; and
a sealant configured to encapsulate the flexible plastic substrate, the ITO layer and the sensing membrane, wherein a portion of an upper surface of the sensing membrane is exposed to form a sensing window;
a readout circuit configured to read an output signal from the flexible pH sensor; and
a conductor having a first end connected to the flexible pH sensor and a second end connected to the readout circuit.

7. The pH sensing system of claim 6, further comprising a reference electrode configured to provide a stable potential.

8. The pH sensing system of claim 6 or 7, wherein the first end of the conductor is connected to the ITO layer of the flexible pH sensor.

9. The pH sensing system of claim 6 or 7, wherein the flexible plastic substrate is made of polyethylene terephthalate (PET).

10. The pH sensing system of claim 6 or 7, wherein the sensing membrane is a tin dioxide (SnO₂) film.

11. The pH sensing system of claim 6 or 7, wherein the sealant is an epoxy resin.

12. The pH sensing system of claim 6 or 7, wherein the readout circuit is an instrumentation amplifier.

13. The pH sensing system of claim 7, wherein the reference electrode is a silver/silver chloride (Ag/AgCl) electrode.
